(19) United States
(12) Patent Application Publication
(10) Pub. No.: US 2013/0334468 A1
(43) Pub. Date: Dec. 19, 2013

(54) NEGATIVE ELECTRODE MATERIAL FOR NONAQUEOUS ELECTROLYTE SECONDARY BATTERY AND METHOD FOR MANUFACTURING THE SAME

(71) Applicants: Naoetsu Electronics Co., Ltd., Joetsu-shi (JP); SHIN-ETSU CHEMICAL CO., LTD., Tokyo (JP)

(72) Inventors: Kazuyuki TANIGUCHI, Annaka (JP); Tetsuo NAKANISHI, Annaka (JP); Katsuyuki ISOGAI, Joetsu (JP); Shoichi KOBAYASHI, Joetsu (JP)

(21) Appl. No.: 13/912,598

(22) Filed: Jun. 7, 2013

(30) Foreign Application Priority Data
Jun. 13, 2012 (JP) 2012-133880

(51) Int. Cl. H01M 4/36; H01M 4/04

(52) U.S. Cl. CPC H01M 4/364; H01M 4/043
USPC 252/502

(57) ABSTRACT

The present invention provides a method for manufacturing a negative electrode material for a nonaqueous electrolyte secondary battery, which includes the steps of: preparing silicon nanoparticles; manufacturing the silicon-carbon composite material that contains the silicon nanoparticles and a carbonaceous material; and heat-compressing the silicon-carbon composite material. As a result, there is provided a negative electrode material for a nonaqueous electrolyte secondary battery, which has a high capacity and excellent initial charge/discharge efficiency and cycle characteristics and a method for manufacturing the same, and a nonaqueous electrolyte secondary battery that uses the negative electrode material for a nonaqueous electrolyte secondary battery.

### TECHNICAL FIELD

The present invention relates to a negative electrode material for a nonaqueous electrolyte secondary battery such as a lithium ion secondary battery and a method for manufacturing the same, and a nonaqueous electrolyte secondary battery that uses the negative electrode material for a nonaqueous electrolyte secondary battery.

### BACKGROUND ART

Recently, as portable electronic devices and communication devices and electric cars develop remarkably, from the viewpoint of economic efficiency, and long life and miniaturization and weight saving of devices, a nonaqueous electrolyte secondary battery having a high capacity and a high energy density is in strong demand.

Therefore, a silicon-based active material having a high theoretical capacity is gathering attention as a negative electrode material. However, a problem is known that a silicon-based active material is large in volume change accompanying charge/discharge; accordingly, during repeating charge/discharge, particles of active material itself collapse and come off a current collector, and a conductive path is cut to degrade cycle characteristics.

As a means for mitigating the volume change accompanying charge/discharge and for maintaining the conductive path, a method of coating silicon particles with a carbonaceous material (carbon) has been proposed. For example, a method where silicon particles and a resin are mixed and granulated and the resin is carbonized, which is described in Patent Document 1 for example, and a method where silicon particles and a conductive material are dispersed in a solvent, thereafter, the mixture is granulated by spray-drying, which is described in Patent Document 2, have been reported.

### CITATION LIST

### Patent Documents

Patent Document 1: Japanese Patent No. 4281099
Patent Document 2: Japanese Patent No. 3987853

### SUMMARY OF INVENTION

As was described above, in Patent Documents 1 and 2, as a means for mitigating the volume change accompanying charge/discharge and for maintaining the conductive path, a method of coating silicon particles with a conductive material such as carbon has been proposed. However, according to study of the present inventors, it was found that by only coating silicon particles with carbon, silicon particles and carbon are separated during repeating charge/discharge to cut the conductive path to result in degrading cycle characteristics.

The present invention was conducted in view of the above situations and intends to provide a negative electrode material for a nonaqueous electrolyte secondary battery, which has a high capacity and excellent initial charge/discharge efficiency and cycle characteristics, and a method for manufacturing the same, and a nonaqueous electrolyte secondary battery that uses the negative electrode material for a nonaqueous electrolyte secondary battery.

In order to solve the problem, the present invention provides a method for manufacturing a negative electrode material for a nonaqueous electrolyte secondary battery, including the steps of: preparing silicon nanoparticles; manufacturing a silicon-carbon composite material that contains the silicon nanoparticles and a carbonaceous material; and heat-compressing the silicon-carbon composite material.

According to the method for manufacturing a negative electrode material for a nonaqueous electrolyte secondary battery, by heat-compressing the silicon-carbon composite material, the adhesiveness between the silicon component and the carbon component in the silicon-carbon composite material can be increased, a volume change owing to charge/discharge can be suppressed, and conductivity can be improved. As a result, a negative electrode material for a nonaqueous electrolyte secondary battery, which is suppressed from degrading in cycle characteristics owing to separation of the silicon component and the carbon component owing to repetition of charge/discharge and has a high capacity and excellent cycle characteristics, can be manufactured.

In this case, the silicon-carbon composite material can be manufactured by coating a surface of the silicon nanoparticles with the carbonaceous material.

Further, the silicon-carbon composite material can be manufactured also by preparing a mixture of the silicon nanoparticles and the carbonaceous material.

Thus, by heat-compressing only the silicon nanoparticles coated with the carbonaceous material or the mixture of the silicon nanoparticles and the carbonaceous material, adhesiveness between the silicon component and the carbon component is increased, the volume change owing to charge/discharge can be suppressed, and conductivity can be improved.

Further, according to the method for manufacturing a negative electrode material for a nonaqueous electrolyte secondary battery of the present invention, pressure in the step of heat-compressing is preferably set to 50 MPa or more and 300 MPa or less.

Thus, by conducting the step of heat-compressing under pressure of 50 MPa or more, an effect of improving the adhesiveness between silicon and carbon can be sufficiently obtained. Further, by conducting the step of heat-compressing under pressure of 300 MPa or less, in the silicon nanoparticles, crack can be prevented from occurring.

Further, a temperature in the step of heat-compressing is preferably set to 1300° C. or less.

Thus, when the step of heat-compressing is conducted at a temperature equal to or less than 1300° C., electrically inactive silicon carbide can be prevented from occurring.

Further, a ratio of a mass of the carbonaceous material with respect to a mass of the silicon-carbon composite material is preferably set to 3% by mass or more.

When a mass ratio of the carbonaceous material is set to 3% by mass or more like this, effects such as an improvement in conductivity and an improvement in cycle characteristics can be sufficiently obtained.

Further, the present invention provides a negative electrode material for a nonaqueous electrolyte secondary battery, which is manufactured according to any one of the methods for manufacturing a negative electrode material for a nonaqueous electrolyte secondary battery.

Still further, the present invention provides a negative electrode material for a nonaqueous electrolyte secondary battery, which includes a silicon-carbon composite material configured of silicon nanoparticles and a carbonaceous material, wherein the silicon-carbon composite material is heat-compressed.

According to the negative electrode material for a nonaqueous electrolyte secondary battery, by suppressing volume change owing to charge/discharge or by improving conductivity, a negative electrode material for a nonaqueous electrolyte secondary battery having a high capacity and excellent cycle characteristics can be obtained.

In this case, a ratio of a mass of the carbonaceous material with respect to a mass of the silicon-carbon composite material is preferably 3% by mass or more.

When a carbon amount is set like this, effects such as an improvement in the conductivity and an improvement in cycle characteristics can be sufficiently obtained.

Further, the present invention provides a nonaqueous electrolyte secondary battery that uses any of the negative electrode materials for a nonaqueous electrolyte secondary battery.

According to the nonaqueous electrolyte secondary battery, by suppressing volume change owing to charge/discharge or by improving conductivity, a nonaqueous electrolyte secondary battery having a high capacity and excellent cycle characteristics can be obtained.

In the negative electrode material for a nonaqueous electrolyte secondary battery according to the present invention, the silicon-carbon composite material is heat-compressed; accordingly, adhesiveness between the silicon component and the carbon component in the silicon-carbon composite material is increased, the volume can be prevented from changing owing to charge/discharge, and conductivity can be improved. As a result, since the cycle characteristics can be suppressed from degrading owing to separation of the silicon component and the carbon component, the negative electrode material for a nonaqueous electrolyte secondary battery, which has a high capacity and excellent cycle characteristics, can be manufactured.

Further, according to the method for manufacturing a negative electrode material for a nonaqueous electrolyte secondary battery according to the present invention, such a negative electrode material for a nonaqueous electrolyte secondary battery can be easily manufactured and can sufficiently sustain industrial-scale manufacturing.

Further, the nonaqueous electrolyte secondary battery that uses the negative electrode material for a nonaqueous electrolyte secondary battery according to the present invention has a battery structure which is substantially the same as that of a general nonaqueous electrolyte secondary battery; accordingly, its manufacture is easy and there is no problem in mass-production.

### DESCRIPTION OF EMBODIMENTS

Hereinafter, the present invention will be detailed. However, the present invention is not limited thereto.

The negative electrode material for a nonaqueous electrolyte secondary battery of the present invention is a negative electrode material that contains a silicon-carbon composite material configured of silicon nanoparticles and a carbonaceous material (carbon), wherein the silicon-carbon composite material is heat-compressed. In particular, the silicon-carbon composite material is preferably obtained by heat-compressing the silicon nanoparticles a surface of which is coated with the carbonaceous material, or by heat-compressing a mixture of the silicon nanoparticles and the carbonaceous material.

When the silicon-carbon composite material is heat-compressed, adhesiveness between the silicon component and the carbon component in the silicon-carbon composite material is increased, the volume can be prevented from changing owing to charge/discharge, and conductivity can be improved. As a result, the negative electrode material for a nonaqueous electrolyte secondary battery, which is suppressed from degrading in cycle characteristics owing to separation of the silicon component and the carbon component owing to repetition of charge/discharge, has a high capacity and excellent cycle characteristics, can be manufactured. Further, such a negative electrode material for a nonaqueous electrolyte secondary battery can be manufactured according to a convenient method and can sufficiently sustain industrial-scale manufacturing.

A ratio of a mass of the carbonaceous material, with respect to a mass of the silicon-carbon composite material is preferably 3% by mass or more. When the carbon amount in the silicon-carbon composite material is 3% by mass or more, effects such as an improvement in the conductivity and an improvement in cycle characteristics can be sufficiently obtained. On the other hand, the carbon amount has no particular upper limitation and can be adjusted by considering a charge/discharge capacity of a target negative electrode material. When the carbon amount is within the range, a negative electrode material for a nonaqueous electrolyte secondary battery which has a high capacity and improved cycle characteristics can be obtained.

Hereinafter, the negative electrode material for a nonaqueous electrolyte secondary battery of the present invention and the method for manufacturing the same, and a nonaqueous electrolyte secondary battery that used the negative electrode material will be detailed.

Firstly, the negative electrode material for a nonaqueous electrolyte secondary battery and the method for manufacturing the same will de described.

Firstly, silicon nanoparticles are prepared. The silicon nanoparticles in the present invention have a value of D₅₀ in a particle size distribution measurement according to a laser diffraction method in the range of 20 nm to 1 μm. When silicon particles having such a particle size are used, the volume change during charge/discharge can be reduced and cycle characteristics can be improved. Further, a specific surface area obtained according to a BET method of the silicon nanoparticles is preferably 10 m²/g or more and 100 m²/g or less. When a specific surface area of the silicon nanoparticles is 10 m²/g or more, in the silicon nanoparticles that have a value of D₅₀ in the range, abundance of particles having a particle size of 1 μm or more is slight, and a reduction effect of the volume change during charge/discharge can be sufficiently obtained. Further, when particles have a specific surface area of 100 m²/g or less, an amount of silicon oxide generated on a surface of particles can be suppressed, and a charge/discharge capacity and an initial charge/discharge efficiency can be prevented from degrading.

Next, the silicon-carbon composite material containing the silicon nanoparticles and the carbonaceous material is prepared. The silicon-carbon composite material can be prepared specifically by coating a surface of the silicon nanoparticles with the carbonaceous material, or by preparing a mixture of the silicon nanoparticles and the carbonaceous material.

Firstly, an embodiment where the silicon-carbon composite material is prepared by coating a surface of the silicon nanoparticles with the carbonaceous material will be described.

The particles (silicon-carbon composite particles) where the silicon nanoparticles are coated with the carbonaceous material in the present invention can be readily formed according to a method where the carbonaceous material is chemical vapor deposited on the silicon nanoparticles, or a method where the silicon nanoparticles are dispersed in a solvent in which a binder is added and granulated by spray-drying.

As the method for chemical vapor depositing the carbonaceous material on the silicon nanoparticles, for example, a method where the silicon nanoparticles are processed in an organic gas, under reduced pressure of 50 Pa to 30,000 Pa, and at a temperature from 700 to 1200° C. can be cited. According to this method, the particles where the silicon nanoparticles are coated with the carbonaceous material can be obtained. The pressure is preferably 50 Pa to 10,000 Pa and more preferably 50 Pa to 2,000 Pa. When degree of decompression is 30,000 Pa or less, a ratio of a graphite material having a graphite structure can be reduced, and, when used as a negative electrode material for a nonaqueous electrolyte secondary battery, a battery capacity can be prevented from degrading and cycle characteristics can be prevented from degrading. A chemical vapor deposition temperature is preferably 800 to 1200° C. and more preferably 900 to 1100° C. When a processing temperature is 800° C. or more, a processing time can be made shorter. On the other hand, when the processing temperature is 1200° C. or lower, fusion and aggregation between particles owing to chemical vapor deposition can be suppressed from occurring; accordingly, a situation where a conductive film is not formed on a coagulation surface can be prevented from occurring. As a result, cycle characteristics when used as a negative electrode material for a nonaqueous electrolyte secondary battery can be prevented from degrading. A processing time is appropriately selected depending on a coating amount of a target carbonaceous material, a processing temperature, and a concentration (flow rate) and an introducing amount of the organic gas. However, it is usually economically efficient to be 1 to 10 hours, in particular, about 2 to 7 hours.

As an organic material used as a raw material that generates the organic gas in chemical vapor deposition of the carbonaceous material, an organic material that is thermally decomposed under a non-oxidizing atmosphere in particular, at the heat treatment temperature to generate carbon (graphite) is selected. For example, hydrocarbons such as methane, ethane, ethylene, acetylene, propane, butane, butene, pentane, isobutane, and hexane and mixtures thereof; and monocyclic to tricyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene or mixtures thereof can be cited. Further, gas light oil, creosote oil, anthracene oil, and tar oil obtained by naphtha cracking, which are obtained in the course of tar distillation, or mixtures thereof can be used.

In the method where the silicon nanoparticles are granulated by spray drying, as the binder, for example, carboxymethylcellulose, polyvinyl alcohol, polyacrylic acid, polyvinylpyrrolidone, polyimide, polyamideimide, and styrene butadiene rubber can be used. A solvent that is used for dispersion is not particularly limited. However, water, or alcohols such as methanol and ethanol are preferable. Further, the binder remaining after granulation is preferably thermally carbonized from the viewpoint of an improvement in conductivity.

Then, manufacture of the silicon-carbon composite material will be described according to an embodiment where the mixture of the silicon nanoparticles and the carbonaceous material is prepared.

As the carbonaceous material (carbon) used in the mixture of the silicon nanoparticles and the carbonaceous material in the present invention, graphites such as natural graphite, artificial graphite, various kinds of cokes particles, mesophase carbon, vapor-phase grown carbon fiber, pitch-based carbon fiber, PAN-based carbon fiber and various kinds of resin-sintered bodies can be used. Further, the mixture of the silicon nanoparticles and the carbonaceous material may be granulated before heat compression, and as the granulating method, the spray drying method can be used.

In the silicon-carbon composite material prepared according to these methods, in order to sufficiently improve conductivity and cycle characteristics, a ratio of a mass of the carbonaceous material with respect to a mass of the silicon-carbon composite material is preferably set to 3% by mass or more.

When the silicon-carbon composite material prepared according the method (the silicon nanoparticles coated with carbon, or the mixture of the silicon nanoparticles and the carbonaceous material) is heat-compressed, a general method such as a discharge plasma sintering method, a hot-press method, and a hot isostatic pressing method can be used. Further, in the negative electrode material for a nonaqueous electrolyte secondary battery of the present invention, a silicon-carbon composite material (the silicon nanoparticles coated with carbon, or the mixture of the silicon nanoparticles and the carbonaceous material) is heat-compressed preferably under pressure of 50 MPa or more and 300 MPa or less. Further, the heat compression is preferably conducted at a temperature equal to or less than 1300° C.

When pressure in the heat compression is 50 MPa or more, an effect of improving adhesiveness between silicon and carbon can be sufficiently obtained. Further, when pressure in the heat compression is 300 MPa or lower, cracks can be prevented from being generated in the silicon nanoparticles; accordingly, miniaturization due to repetition of charge/discharge can be prevented from proceeding and thereby cycle characteristics can be prevented from being degraded. When heat compression temperature is 1300° C. or less, electrically inactive silicon carbide can be suppressed from being generated. As a result, degradation of a capacity or degradation of conductivity, which is caused by generation of abundant silicon carbide, can be prevented from occurring.

A silicon-carbon composite material after heat compression (pressure-molded body) can be crushed into a manageable particle size. A particle size of the silicon-carbon composite material after crushing can be set to 2 μm to 200 μm, for example.

In a manner as was described above, the negative electrode material for a nonaqueous electrolyte secondary battery according to the present invention can be manufactured.

When the negative electrode material according to the present invention is used in a nonaqueous electrolyte secondary battery, in the negative electrode, in addition to the negative electrode material (silicon-carbon composite material after heat compression) according to the present invention, a conductive agent such as metal particles, carbon, and graphite can be added. Also in this case, the kind of the conductive agent is not particularly limited, and an electron conductive material that is not decomposed or modified in a configured battery can be used.

Specifically, particles or fibers of metals such as Al, Ti, Fe, Ni, Cu, Zn, Ag, Sn and Si or graphites such as natural graphite, artificial graphite, various kinds of cokes particles, mesophase carbon, vapor-phase grown carbon fiber, pitch-based carbon fiber, PAN-based carbon fiber and various kinds of resin-sintered bodies can be added to the negative electrode.

Further, the nonaqueous electrolyte includes a nonaqueous organic solvent and an electrolyte dissolved therein.

As the electrolyte (electrolytic solution), electrolytes generally used as an electrolyte for a nonaqueous electrolyte secondary battery can be selected without particular limitation. Examples thereof include LiPF₆, LiN(CF₃SO₂)₂, LiN(C₂F₅SO₂)₂, LiClO₄, LiBF₄, LiSO₃CF₃, LIBOB, LiFOB, LiDFOB or mixtures thereof.

As the nonaqueous organic solvent, nonaqueous organic solvents known as usable as an electrolyte for a nonaqueous electrolyte secondary battery can be appropriately selected and used without particular limitation.

For example, organic solvents such as cyclic carbonates such as ethylene carbonate, propylene carbonate, fluoroethylene carbonate, and difluoroethylene carbonate; chain carbonates such as dimethyl carbonate, diethyl carbonate, and ethyl methyl carbonate; γ-butyrolactone, dimethoxyethane, tetrahydropyran, N,N-dimethyl formamide, ether containing a perfluoropolyether group (see JP 2010-146740 A) or mixtures thereof can be cited.

Further, in the nonaqueous organic solvents, an optional additive can be used in an appropriate optional amount. Examples thereof include cyclohexylbenzene, biphenyl, vinylene carbonate, succinic anhydride, ethylene sulfite, propylene sulfite, dimethyl sulfite, propane sultone, butane sultana, methyl methanesulfonate, methyl toluenesulfonate, dimethyl sulfate, ethylene sulfate, sulfolane, dimethyl sulfone, diethyl sulfone, dimethyl sulfoxide, diethyl sulfoxide, tetramethylene sulfoxide, diphenyl sulfide, thioanisole, diphenyl disulfide, and dipyridinium disulfide.

Then, as a positive electrode that can occlude and release lithium ions, for example, oxides, chalcogenides, or lithium compounds of transition metal such as LiCoO₂, LiNiO₂, LiMn₂O₄, LiNiMnCoO₂, LiFePO₄, LiVOPO₄, V₂O₅, MnO₂, TiS₂ and MoS₂ can be used.

A nonaqueous electrolyte secondary battery of the present invention includes the negative electrode for a nonaqueous electrolyte secondary battery, the positive electrode and the electrolyte, which have above-described features, and as a material of a separator as other constituents and battery shape, known materials and shapes can be used without particular limitation.

For example, a shape of the nonaqueous electrolyte secondary battery is optional without particular limitation. In general, the battery is of the coin type wherein electrodes and a separator, all punched into coin shape, are stacked, or of the rectangular or cylinder type wherein electrode sheets and a separator are spirally wound.

Further, the separator used between the positive electrode and the negative electrode is not particularly limited as long as it is stable to the electrolyte and excellent in water retention property. Generally, porous sheets of polyolefins such as polyethylene and polypropylene and copolymers thereof or aramid resins or nonwoven fabrics can be cited. These can be used in a single layer or by stacking into multi-layers, and on a surface thereof, ceramics such as metal oxide can be laminated. Further, porous glass and ceramics can be used as well.

The nonaqueous electrolyte secondary battery according to the present invention has a battery structure which is substantially the same as that of a general nonaqueous electrolyte secondary battery; accordingly, its manufacture is easy and there is no problem in mass-production.

### EXAMPLES

Hereinafter, with reference to Examples and Comparative Examples of the present invention, the present invention will be more detailed. The present invention is not limited thereto and can be appropriately modified within the range of technical features described in claims.

### Example 1

A negative electrode material was prepared according to the following method, and a battery was prepared with the negative electrode material and evaluated.

### <Preparation of Negative Electrode Material>

By using methane as a carbon source, 50 g of silicon nanopowder having an average particle size of 200 nm was coated with a carbonaceous material (carbon coating) by chemical vapor deposition. An amount of carbon contained in the carbon-coated silicon nanoparticles (silicon-carbon composite material) thus prepared was measured with a carbon analyzer (manufactured by Horiba Ltd.) and found to be 3% by mass. The prepared carbon-coated silicon nanoparticles were heat-compressed with a discharge plasma sintering machine (manufactured by Fuji Dempa Kogyo Co., Ltd.) under conditions of pressure of 50 MPa and temperature of 1300° C. for 10 minutes, and a block-like pressure-molded body was obtained. By crushing the resulted pressure-molded body with an automatic mortar to an average particle size of 10 μm, a target negative electrode material was obtained.

### <Preparation of Electrode>

By mixing 85% by mass of the prepared negative electrode material and 15% by mass of polyimide, further by adding N-methylpyrrolidone, a slurry was prepared. The slurry was coated on both sides of a copper foil having a thickness of 11 μm, after drying at 100° C. for 30 minutes, an electrode was pressure molded with a roller press, and the electrode was vacuum dried at 400° C. for 2 hours. Thereafter, by punching into 2 cm², a negative electrode was obtained.

On the other hand, by mixing 94% by mass of lithium cobalt oxide, 3% by mass of acetylene black and 3% by mass of polyvinylidene fluoride, further by adding N-methylpyrrolidone, a slurry was prepared, and the slurry was coated an an aluminum foil having a thickness of 16 μm. The slurry coated on an aluminum foil was dried at 100° C. for 1 hr, thereafter an electrode was pressure molded with a roller press, and the electrode was vacuum dried at 120° C. for 5 hours. Thereafter, by punching into 2 cm², a positive electrode was formed,

### <Preparation of Coin-Shape Battery>

With the prepared negative electrode and positive electrode, a nonaqueous electrolyte obtained by dissolving LiPF₆ in a 1:1 (by volume ratio) mixed solution of ethylene carbonate and diethyl carbonate at a concentration of 1 mol/L, and a separator of a polypropylene microporous film having a thickness of 20 μm, a coin-shaped lithium ion secondary battery for evaluation was prepared.

### <Battery Evaluation>

The prepared coin-shaped lithium ion secondary battery was, after leaving at room temperature for overnight, subjected to charge/discharge by using a secondary battery charge/discharge tester (manufactured by Aska Electronic Co., Ltd.). Firstly, until a voltage of a test cell reached 4.2 V, charge was conducted at a constant current of 1.4 mA/cm², after reaching 4.2 V, charge was conducted by reducing a current so as to maintain a cell voltage at 4.2 V, and when a current value became smaller than 0.28 mA/cm², the charge was terminated. Discharge was conducted at a constant current of 1.4 mA/cm², when a cell voltage reached 2.5 V, the discharge was terminated, and according the above-described operation, an initial charge/discharge capacity and an initial charge/discharge efficiency were obtained.

By repeating the charge/discharge test, a capacity retention rate at the 50th cycle was calculated according to the following calculation formula: capacity retention rate (%) at the 50th cycle=discharge capacity at the second cycle/discharge capacity at the 50th cycle. Above results are shown in Table 1.

### Example 2

### Preparation of Negative Electrode Material

By heating carbon-coated silicon nanoparticles obtained according to the same method as that of Example 1 under pressure condition of 300 MPa at 600° C. for 10 minutes with the discharge plasma sintering machine, a block-like pressure-molded body was obtained. By crushing the resulted pressure-molded body with the automatic mortar to an average particle size of 10 μm, a target negative electrode material was obtained.

With the negative electrode that was prepared by using the prepared negative electrode material according to the same method as that of Example 1, the positive electrode, and the electrolyte, a coin-shaped lithium ion secondary battery for evaluation was prepared. The prepared lithium ion secondary battery was subjected to battery evaluation in the same manner as that of Example 1. Results thereof are shown in Table 1.

### Example 3

### Preparation of Negative Electrode Material

With methane as a carbon source, carbon was coated on 50 g of silicon nanoparticles that have an average particle size of 200 nm and a specific surface area obtained by BET method of 23 m²/g by chemical vapor deposition. An amount of carbon contained in thus the prepared carbon-coated silicon nanoparticles was measured with the carbon analyzer and found to be 20% by mass. By heating the resulted carbon-coated silicon nanoparticles with the discharge plasma sintering machine under condition of pressure of 50 MPa and temperature of 1100° C. for 10 minutes, a block-shaped pressure-molded body was obtained. By crushing the resulted pressure-molded body with the automatic mortar to an average particle size of 10 μm, a target negative electrode material was obtained.

With the negative electrode prepared with the prepared negative electrode material according to the same method as that of Example 1, the positive electrode, and the electrolyte, a coin-shaped lithium ion secondary battery for evaluation was prepared. The prepared lithium ion secondary battery was subjected to battery evaluation in the same manner as that of Example 1. Results thereof are shown in Table 1.

### Example 4

### Preparation of Negative Electrode Material

150 g of silicon nanoparticles that have an average particle size of 200 nm and a specific surface area obtained by BET method of 23 m²/g, 150 g of flake graphite, and 200 g of carboxymethylcellulose were mixed in ion-exchanged water and granulated by spray drying. An amount of carbon contained in the mixture of silicon nanoparticles and flake graphite (silicon-carbon composite material) thus prepared was measured with the carbon analyzer and found to be 50% by mass. By heating particles obtained by the granulation with the discharge plasma sintering machine under condition of pressure of 50 MPa and temperature of 1100° C. for 10 minutes, a block-shaped pressure-molded body was obtained. By disintegrating the resulted pressure-molded body with the automatic mortar to an average particle size of 10 μm, a target negative electrode material was obtained.

With the negative electrode prepared with the prepared negative electrode material according to the same method as that of Example 1, the positive electrode, and an electrolyte, the coin-shaped lithium ion secondary battery for evaluation was prepared. The prepared lithium ion secondary battery was subjected to battery evaluation in a manner in the same manner as that of Example 1. Results thereof are shown in Table 1.

### Comparative Example 1

### Preparation of Negative Electrode Material

With methane as a carbon source, 50 g of silicon nanoparticles that have an average particle size of 200 nm and a specific surface area obtained by BET method of 23 m²/g was coated with carbon by chemical vapor deposition. An amount of carbon contained in the carbon-coated silicon nanoparticles thus prepared was measured with the carbon analyzer and found to be 3% by mass. The carbon-coated silicon nanoparticles were used as a negative electrode material as they are (that is, without subjecting to heat-compression).

With the negative electrode prepared with the prepared negative electrode material according to the same method as that of Example 1, the positive electrode, and the electrolyte, a coin-shaped lithium ion secondary battery for evaluation was prepared. The prepared lithium ion secondary battery was subjected to battery evaluation in the same manner as that of Example 1. Results thereof are shown in Table 1.

### Comparative Example 2

### Preparation of Negative Electrode Material

With methane as a carbon source, 50 g of silicon nanoparticles that have an average particle size of 200 nm and a specific surface area obtained by BET method of 23 m²/g was coated with carbon by chemical vapor deposition. An amount of carbon contained in the carbon-coated silicon nanoparticles thus prepared was measured with the carbon analyzer and found to be 20% by mass. The carbon-coated silicon nanoparticles were used as a negative electrode material as they are (that is, without subjecting to heat compression).

With the negative electrode prepared with the prepared negative electrode material according to the same method as that of Example 1, the positive electrode, and the electrolyte, a coin-shaped lithium ion secondary battery for evaluation was prepared. The prepared lithium ion secondary battery was subjected to battery evaluation in the same manner as that of Example 1. Results thereof are shown in Table 1.

### Comparative Example 3

### Preparation of Negative Electrode Material

150 g of silicon nanoparticles that have an average particle size of 200 nm and a specific surface area obtained by BET method of 23 m²/g, 150 g of flake graphite, and 200 g of carboxymethylcellulose were mixed in ion-exchanged water, and the mixture was granulated by spray drying. An amount of carbon contained in the mixture of silicon nanoparticles and flake graphite thus prepared was measured with the carbon analyzer and found to be 50% by mass. The mixture was used as a negative electrode material as they are (that is, without subjecting to heat compression).

With the negative electrode prepared with the prepared negative electrode material according to the same method as that of Example 1, the positive electrode, and the electrolyte, a coin-shaped lithium ion secondary battery for evaluation was prepared. The prepared lithium ion secondary battery was subjected to battery evaluation in the same manner as that of Example 1. Results thereof are shown in Table 1.

TABLE 1

| | | | | | Initial | Capacity |
|---|---|---|---|---|---|---|
| | | | | Initial | charge/ | retention |
| | Carbon | | Temper- | charge | discharge | rate after |
| | amount | Pressure | ature | capacity | efficiency | 50 cycles |
| | (%) | (MPa) | (° C.) | (mAh/g) | (%) | (%) |
| Example 1 | 3 | 50 | 1300 | 2400 | 81 | 69 |
| Example 2 | 3 | 300 | 600 | 2500 | 82 | 71 |
| Example 3 | 20 | 50 | 1100 | 1900 | 85 | 77 |
| Example 4 | 50 | 50 | 1100 | 1300 | 82 | 85 |
| Comparative | 3 | — | — | 2500 | 82 | 42 |
| example 1 | | | | | | |
| Comparative | 20 | — | — | 2000 | 86 | 56 |
| example 2 | | | | | | |
| Comparative | 50 | — | — | 1300 | 78 | 38 |
| example 3 | | | | | | |

From results of Table 1, it was found that cycle characteristics of each of Example 1 where heat compression was applied to the silicon nanoparticles coated with 3% by mass of carbon by chemical vapor deposition under condition of pressure of 50 MPa and temperature of 1300° C., and Example 2 where heat compression was applied to the silicon nanoparticles under condition of pressure of 300 MPa and temperature of 600° C. are improved compared with that of Comparative Example 1 where heat compression was not applied.

Similarly, it was found that cycle characteristics of Example 3 where heat compression was applied to the silicon nanoparticles coated with 20% by mass of carbon by chemical vapor deposition under condition of pressure of 50 MPa and temperature of 1100° C. are improved compared with that of Comparative Example 2 where heat compression was not applied.

Further, it was found that cycle characteristics of Example 4 where heat compression was applied to the mixture of 50% by mass of flake graphite and silicon nanoparticles, which was granulated by spray drying, under condition of pressure of 50 MPa and temperature of 1100° C. are improved compared with that of Comparative Example 3 where heat compression was not applied.

The present invention is not limited to the embodiments. The embodiments are only illustrations and all that has substantially the same configuration with technical idea described in claims of the present invention and has the same effects are contained in the technical range of the present invention.

What is claimed is:

1. A method for manufacturing a negative electrode material for a nonaqueous electrolyte secondary battery, comprising the steps of:
preparing silicon nanoparticles;
manufacturing a silicon-carbon composite material that contains the silicon nanoparticles and a carbonaceous material; and
heat-compressing the silicon-carbon composite material.

2. The method for manufacturing a negative electrode material for a nonaqueous electrolyte secondary battery according to claim 1, wherein the silicon-carbon composite material is manufactured by coating a surface of the silicon nanoparticles with the carbonaceous material.

3. The method for manufacturing a negative electrode material for a nonaqueous electrolyte secondary battery according to claim 1, wherein the silicon-carbon composite material is manufactured by preparing a mixture of the silicon nanoparticles and the carbonaceous material.

4. The method for manufacturing a negative electrode material for a nonaqueous electrolyte secondary battery according to claim 1, wherein pressure in the step of heat-compressing is 50 MPa or more and 300 MPa or less.

5. The method for manufacturing a negative electrode material for a nonaqueous electrolyte secondary battery according to claim 2, wherein pressure in the step of heat-compressing is 50 MPa or more and 300 MPa or less.

6. The method for manufacturing a negative electrode material for a nonaqueous electrolyte secondary battery according to claim 3, wherein pressure in the step of heat-compressing is 50 MPa or more and 300 MPa or less.

7. The method for manufacturing a negative electrode material for a nonaqueous electrolyte secondary battery according to claim 1, wherein a temperature in the step of heat-compressing is set to 1300° C. or less.

8. The method for manufacturing a negative electrode material for a nonaqueous electrolyte secondary battery according to claim 2, wherein a temperature in the step of heat-compressing is set to 1300° C. or less.

9. The method for manufacturing a negative electrode material for a nonaqueous electrolyte secondary battery according to claim 3, wherein a temperature in the step of heat-compressing is set to 1300° C. or less.

10. The method for manufacturing a negative electrode material for a nonaqueous electrolyte secondary battery according to claim 4, wherein a temperature in the step of heat-compressing is set to 1300° C. or less.

11. The method for manufacturing a negative electrode material for a nonaqueous electrolyte secondary battery according to claim 1, wherein a ratio of a mass of the carbonaceous material with respect to a mass of the silicon-carbon composite material is set to 3% by mass or more.

12. The method for manufacturing a negative electrode material for a nonaqueous electrolyte secondary battery according to claim 2, wherein a ratio of a mass of the carbonaceous material with respect to a mass of the silicon-carbon composite material is set to 3% by mass or more.

13. The method for manufacturing a negative electrode material for a nonaqueous electrolyte secondary battery according to claim 3, wherein a ratio of a mass of the carbonaceous material with respect to a mass of the silicon-carbon composite material is set to 3% by mass or more.

14. The method for manufacturing a negative electrode material for a nonaqueous electrolyte secondary battery according to claim 4, wherein a ratio of a mass of the carbonaceous material with respect to a mass of the silicon-carbon composite material is set to 3% by mass or more.

15. The method for manufacturing a negative electrode material for a nonaqueous electrolyte secondary battery according to claim 7, wherein a ratio of a mass of the carbonaceous material with respect to a mass of the silicon-carbon composite material is set to 3% by mass or more.

16. A negative electrode material for a nonaqueous electrolyte secondary battery, which is manufactured according to a method for manufacturing a negative electrode material for a nonaqueous electrolyte secondary battery according to claim 1.

17. A negative electrode material for a nonaqueous electrolyte secondary battery, which includes a silicon-carbon composite material configured of silicon nanoparticles and a carbonaceous material, wherein the silicon-carbon composite material is heat-compressed.

18. The negative electrode material for a nonaqueous electrolyte secondary battery according to claim 17, wherein a ratio of a mass of the carbonaceous material with respect to a mass of the silicon-carbon composite material is set to 3% by mass or more.

19. A nonaqueous electrolyte secondary battery comprising:
the negative electrode material for a nonaqueous electrolyte secondary battery according to claim 17.

20. A nonaqueous electrolyte secondary battery comprising:
the negative electrode material for a nonaqueous electrolyte secondary battery according to claim 18.
